(19) United States
(12) Patent Application Publication
(10) Pub. No.: US 2004/0013461 A1
(43) Pub. Date: Jan. 22, 2004

(54) Flask for medicinal preparations

(76) Inventors: Vladimir Nikolaevich Denisov, Kazanskaya (RU); Arthur Vladimirovich Zatulyakin, Nevelsk ul Severnaya (RU); Grigory Grigorievich Berezin, Ostrovskogo (RU); Valentina Vasilievna Berezina, Ostrovskogo (RU)

Correspondence Address: McCormick Paulding & Huber, CityPlace II, 185 Asylum Street, Hartford, CT, 06103, US

(21) Appl. No.: 10/275,780

(22) PCT Filed: May 10, 2001
(86) PCT No.: PCT/RU01/00191

(30) Foreign Application Priority Data
May 11, 2000 (RU) 2000111276

(51) Int. Cl. B43K 5/00

(52) U.S. Cl. 401/196; 401/198; 401/261

(57) ABSTRACT

A flask for medicinal preparations comprises an elastic receptacle (1) with an orifice in the form of a neck (2), a porous plug-rod (3) arranged inside the receptacle and having one end extending out of the receptacle, and a sealing cap (7) placed above the neck of the receptacle. The elastic receptacle (1) is provided with a head piece (5) having an orifice of size not exceeding a cross-sectional area of the porous rod. A part of the porous rod disposed inside the receptacle has a cross-sectional area larger than the passage area of the receptacle neck orifice. The porous rod (3) is provided with axial notches (9) located on opposite sides of the rod. The porous rod (3) can be of circular or rectangular or polygonal cross-section. The flask is equipped additionally with a rigid body (8) embracing the elastic receptacle and mounted on the head piece (5) of the receptacle by means of a releasable connection. In addition, a spring clip (10) mounted on the outer surface of the sealing cap is provided.

### FIELD OF THE INVENTION

The invention relates to medical equipment, in particular dosing flasks for medicinal preparations, and can be used as personal means for first medical aid in case of cuts, bruises, etc.

### BACKGROUND ART

A device for medicinal preparations is described in RU 2042362, A61M35/00, A42D24/22, 1995, which device comprises a body with an orifice. A porous capillary material impregnated with a liquid medicinal preparation is disposed inside the body. A capillary rod passes through the orifice, being adapted to perform linear motion, and having one end in contact with said porous material inside the body and the other end extending outside the body. The rod has a multi-layer structure so that it can be reused providing a proper antiseptic treatment.

However, an amount of the medicinal preparation squeezed from the porous material is limited by capillary forces inherent to the material, and the described device is not suitable for treatment of large wound surfaces. The fitting of the capillary rod in the orifice allows its rather free movement. Thus, where a force is exerted on the bottom part of the body, the rod is capable of being dropped out of the orifice, which impairs consumer property of the device. Besides, the device is not convenient for use during transportation because an accidental squeeze of the elastic receptacle may cause leakage of the medicinal preparation even if a detachable cap placed on the receptacle is provided.

USSR 1805980, A61M35/00, 1993 discloses a flask for medicinal preparations which is closest to the present invention by technical gist. The flask comprises a receptacle with a neck and a porous medium impregnated with a medical preparation solution, an inside hard porous rod with one end extending through the neck outside the receptacle, and a sealing cap placed above the neck. The receptacle and the porous material of the medium are elastic. The solution is prevented from flowing out of the flask by capillary forces inherent to said medium of highly porous material, such as cotton wool, silica gel, etc. The medicinal preparation can be applied to the skin with the porous rod arranged in the neck, said rod is made of, e.g. felt, felted cloth, gauze, etc. and is in contact with the medium impregnated with the solution. The flask is adapted to dose medicinal preparations to be applied to the skin.

However, it is practically impossible to regulate the dosing of a liquid preparation using the known flask, as the porous rod cannot be wetted more intensively because of capillary forces of the porous medium. Squeezing out the medicinal preparation becomes more difficult with the lapse of time and repeated use, and in some cases the solution can be totally blocked due to capillary choking in the outer part of the rod. The choking results from crystallization of an unused part of the preparation which is unable to return to the flask. This prevents an intake of air into the flask and deteriorates the effect of capillary forces of the porous rod. Besides, the porous filling material decreases the payload volume of a liquid in the flask, and may not allow a hydrostatic pressure increase in the region of the neck, especially when using liquid remains. All that makes the device ineffective when sufficiently large surfaces of the wounded skin shall be treated, or the skin shall be intensively wetted. As a result, there is a deterioration in consumer properties of the flask.

Moreover, the elastic casing of the flask is not protected against mechanical damages and accidental squeeze which may cause an unforeseen flow of the medicinal preparation through the rod in the neck. Therefore, the flask is not convenient for transportation, e.g. in a pocket or handbag.

### SUMMARY OF THE INVENTION

The purpose of the invention is to provide a flask for medicinal preparations which is convenient in service and has improved consumer properties. The flask provides a regulated dosing of medicinal preparations and can be used under transient (field) conditions, e.g. in travel.

What is proposed is the flask for medicinal preparations comprising an elastic receptacle with an orifice in the form of a neck, a porous rod arranged inside the receptacle and having one end extending to the outside the receptacle, and a sealing cap placed on the neck of the receptacle. The elastic receptacle equipped with a head piece with an orifice having an area not exceeding a cross-sectional area of the porous rod. The porous rod portion disposed inside the receptacle has a cross-sectional area larger than the passage area of the receptacle neck. The flask is additionally equipped with a rigid body embracing the elastic receptacle and mounted on the head piece by means of a detachable joint. The sealing cap is connected with the head piece of the receptacle also by means of a detachable joint such as a threaded joint. The porous rod is provided with axial notches located on opposing sides of the rod. Additionally a spring clip is mounted on the outer surface of the sealing cap.

### BRIEF DESCRIPTION OF DRAWINGS

The invention is explained by accompanying drawings where FIG. 1 schematically illustrates the inventive flask in a sectional elevation;

FIG. 2 illustrates the cross-sectional view along the lines A-A of FIG. 1 of the flask neck with notches provided on the rod;

FIG. 3 illustrates the cross-sectional view along the lines B-B of FIG. 1 of the flask in embodiment with a rod having a rectangular in cross-section;

FIG. 4 illustrates the cross sectional view along the lines B-B of Fig. of the flask in embodiment with a rod having a circular cross-section; and

FIG. 5 illustrates the same section as on FIG. 4 of the flask with a rod having a polygonal cross-section.

### BEST MODE FOR CARRYING OUT THE INVENTION

A flask for medicinal preparations comprises an elastic receptacle 1 with a neck 2 in which neck a plug-rod 3 made of a porous material is tightly fitted. Said plug-rod is in contact with a liquid medicinal preparation 4. The neck 2 and the rod 3 may have rectangular or circular or polygonal cross-section, as shown on FIG. 3 to 5.

A lower portion of the rod 3 disposed inside the receptacle, is somewhat larger in cross-section than the passage area of the neck 2. It may be achieved, e.g. by forming the rod 3 with a bulge in the lower portion. Alternatively, the thickness of the whole rod may exceed the size of the neck orifice. Thanks to porous structure of the rod, it is installed in the orifice tightly. As a result, the plug-rod 3 is fixed in the neck of the receptacle 1 and is prevented from being pushed out when extra hydraulic pressure is applied to increase a flow of the solution through the plug-rod. The plug-rod 3 may be made of felt, felted cloth, foam-rubber and other porous/fiber materials.

The length of the rod 3 is chosen to allow a repeated use thereof with periodical cutting its outer end which is in contact with the treated surface of the skin. At the same time, due to shortening of the inner portion of the rod 3, the impact of hydrostatic and hydrodynamic pressure of the medicinal preparation is transferred directly to the section of the plug-rod, and the path of the solution through capillaries of the rod is also shortened.

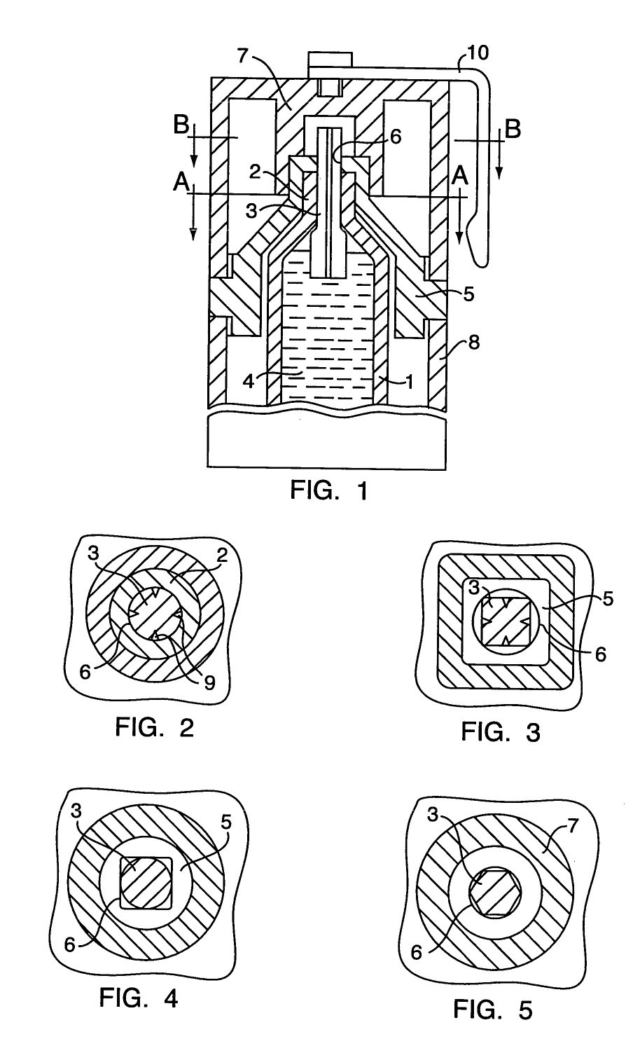

The elastic receptacle 1 is equipped with the head piece 5 tightly fitted on the neck 2 and having an orifice 6, wherein passage area of said orifice does not exceed the cross-sectional area of the rod 3, in order to provide additional friction and keep the rod 3 from being dropped inside the receptacle 1. If the rod 3 is of circular cross-section, the orifice 6 may be made rectangular (square) with a side shorter or equal to the diameter of the rod, as shown on FIG. 2. If the rod 3 is of rectangular cross-section, the orifice 6 may be round, as shown on FIG. 3.

For a disposable flask the head piece 5 may be made integral with the elastic receptacle 1, but of more rigid or thicker material.

For a flask of repeated use the removable head piece 5 allows replacement of the elastic receptacle 1 if it is damaged or the liquid contained therein is fully used up.

One side of the head piece 5 is provided with a sealing cap 7 in the form of a lid hermetically covering the neck 2, and the other side is provided with a rigid body 8 embracing the elastic receptacle 1. Both sealing cap 7 and rigid body 8 are connected to the head piece 5 by means of releasable connection, such as threaded connection. The threaded connection between the head piece 5 and the sealing cap 7 improves hermetic encapsulation of the device, and at the same time allows removal of the elastic receptacle 1 from the body 8. The rigid body 8 prevents damage of the elastic receptacle, thus, troublesome consequences resulting from such destruction are avoided.

In order to improve the wetting of the rod and to ensure the effect of capillary forces, the plug-rod 3 may be provided with notches, e.g. wedge-shaped notches 9, which however may have other forms. The notches are located on opposite sides of the rod along its axis, as shown of FIG. 4. When the elastic receptacle 1 is squeezed and hydrostatic pressure is increased in the region of the neck 2, said notches 9 will be pinched preventing a flow of excessive liquid outside the receptacle. Once the receptacle is released, the notches will get free and allow the air to get to the receptacle 1.

To make the flask convenient in carrying a spring clip 10, such as a clip for fastening a pen in a pocket, is fixedly mounted on the outer surface of the cap 7.

It should be noted that embodiments of different components of the flask, for example, the receptacle, head piece or cap, and materials for manufacturing thereof, are not limited by the description and accompanying drawings. It is understandable that the components can be realized in other forms falling within the scope of the invention, and the description encompasses the best mode for carrying out the invention.

The flask shall be utilized as follows. Being in hand, the flask is turned with the cap 7 downward to ensure a proper wetting and impregnation of the plug-rod 3 with the medicinal preparation 4. The other reason for turning the flask upside-down is to prevent spilling a liquid, which could flow out spontaneously in the course of transportation, on hands or surrounding objects. Then the sealing cap 7 is detached (unscrewed) from the head piece 5 of the receptacle 1, and the preparation is applied to the skin by the plug-rod 3. If more intensive or faster treatment is required, the head piece 5 of the receptacle 1 is grasped with one hand, and the body 8 is detached (unscrewed) with the other hand. After that the receptacle 1 is squeezed to increase the discharge of the preparation, that is to say, to achieve the desired result. The required preparation discharge will be determined by the extent of squeezing the receptacle.

After the treatment is completed the flask shall be reassembled in reverse order.

### INDUSTRIAL APPLICABILITY

The present invention can provide a controlled dosage of medicinal preparations because of the increase of hydraulic pressure of the solution inside the receptacle. The pressure is increased by means of squeezing the receptacle with hands, said squeeze causes the increase of the preparation discharge when the need arises, especially when a large surface shall be treated. The efficiency of the flask is therefore improved. In addition, the invention allows to increase of a volume of medicinal preparation in the flask by several times, as compared to the closest prior art. With a transparent receptacle of the flask, the medicinal preparation therein can be visually controlled. Besides, the flask according to the present invention can be conveniently used in traveling, household and field conditions.

1. Flask for medicinal preparations, comprising an elastic receptacle with an orifice in the form of a neck, a porous rod arranged inside the receptacle and having one end extending to the outside the receptacle, and a sealing cap placed above the neck of the receptacle characterized by that
the elastic receptacle is provided with a head piece having an orifice, which orifice having an area not exceeding a cross-sectional area of the porous rod,
and a part of the porous rod disposed inside the receptacle has a cross-sectional area larger than the passage area of the receptacle neck orifice.

2. Flask according to claim 1 characterized by that it is additionally provided with a rigid body embracing the elastic receptacle and mounted on the head piece of the receptacle by means of a releasable connection.

3. Flask according to claim 2 characterized in that the rigid body is mounted on the head piece of the receptacle by means of a threaded connection.

4. Flask according to claim 1 characterized in that the sealing cap is connected to the head piece of the receptacle by means of a releasable connection.

5. Flask according to claim 4 characterized in that the sealing cap is connected to the head piece of the receptacle by means of a threaded connection.

6. Flask according to claim 1 characterized in that the porous rod is made of circular cross-section.

7. Flask according to claim 1 characterized in that the porous rod is made of rectangular cross-section.

8. Flask according to claim 1 characterized in that the porous rod is made of polygonal cross-section.

9. Flask according to claim 1 characterized in that the porous rod is provided with axial notches.

10. Flask according to claim 9 characterized in that the notches are located on opposite sides of the rod.

11. Flask according to claim 1 characterized by that a spring clip is mounted on the outer surface of the sealing cap.
